(19) United States
(12) Patent Application Publication
(10) Pub. No.: US 2020/0322704 A1
(43) Pub. Date: Oct. 8, 2020

(54) Sound Cloud Ceiling Fan Design

(71) Applicant: Richard Shawn Mosher, Blountstown, FL (US)

(72) Inventor: Richard Shawn Mosher, Blountstown, FL (US)

(21) Appl. No.: 16/373,209

(22) Filed: Apr. 2, 2019

(51) Int. Cl. H04R 1/02

(52) U.S. Cl. CPC H04R 1/025; H04R 2201/021; H04R 1/028; H04R 1/026

(57) ABSTRACT

A wireless capable audio device consisting of a speaker frame, magnet, voice coil, speaker cone, dust cover, suspension and speaker grille. The speaker will be housed in a plastic and/or metal base, which also contains electronics and wiring. The speaker is to be powered by low voltage, which is converted from ac, commonly known as alternating current. The speaker housing will have a lithium battery, to provide power when primary ac (alternating current) is not present, and will be charged by low voltage after being converted from alternating current. The audio device will have a switch mounted on outside to turn off device and will have a wireless remote having batteries to adjust sound output. This audio device is mounted to the bottom of a ceiling fan light kit, which is mounted to a ceiling fan.

An audio speaker intended for entertainment purposes, directly mounted to the bottom exterior of a light kit, that is part of a ceiling fan fixture. This built-in speaker provides audio, from the speaker wirelessly, by connecting to a compatible device such as, but not limited to: cell phones, laptops, personal computers and even tablets. This built-in speaker which is part of a ceiling fan, provides audio entertainment in locations where existing speakers are not present.

### CLAIM #1

Richard S. Mosher claim this improved ceiling fan invention consisting of a ceiling fan with an audio speaker device.

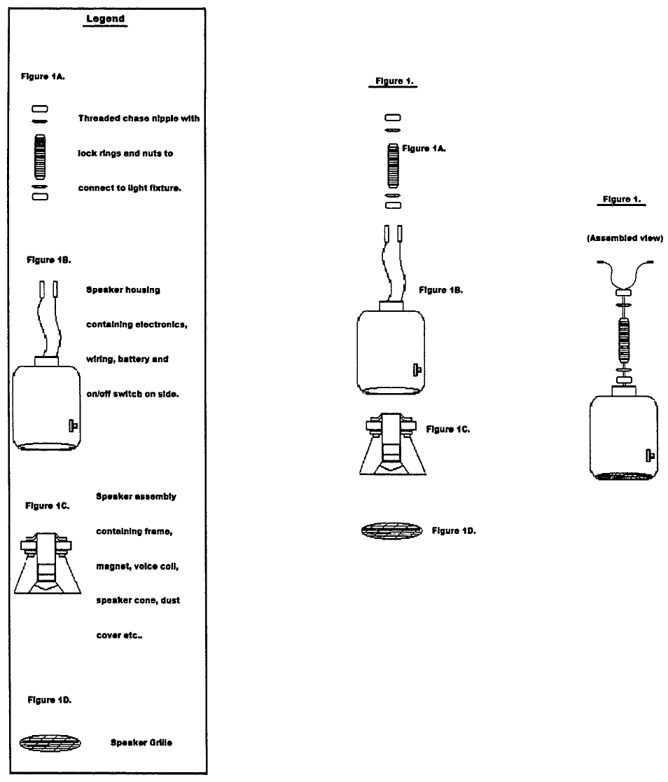

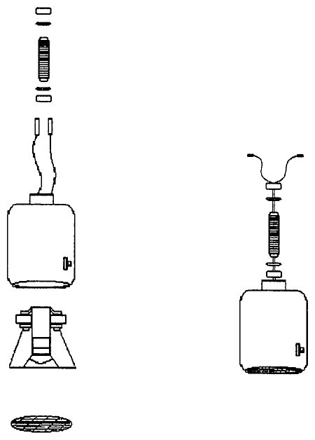

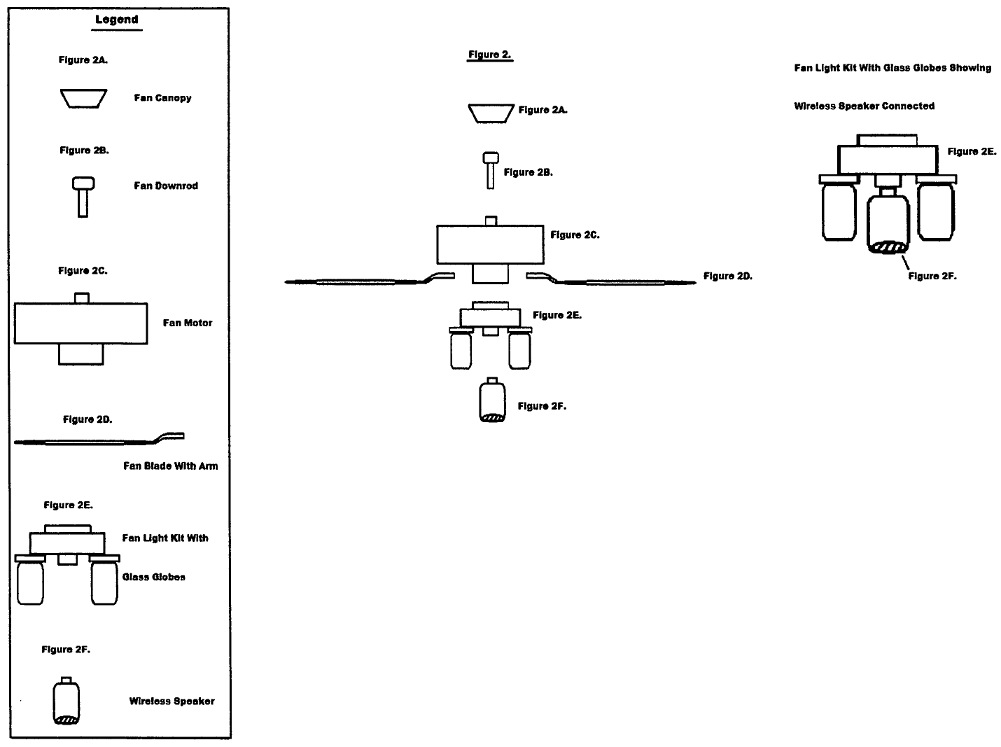

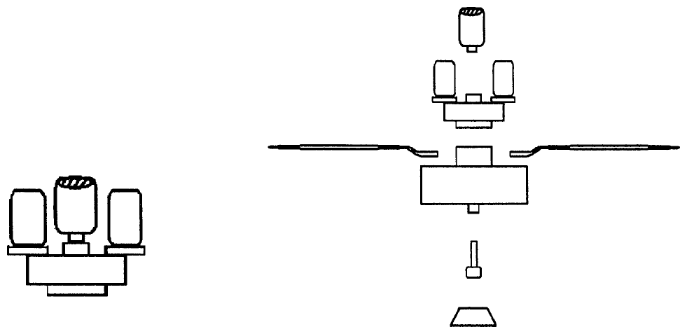

The wireless audio device speaker as shown in (FIG. 1), consists of an outer housing made of plastic and/or metal as shown in (FIG. 1B). This plastic and/or metal housing will contain wiring to be connected to the fan light kit as shown in (FIG. 2) using the parts shown in (FIG. 1A) which consists of a threaded chase nipple, lock rings and nuts. The plastic and/or metal housing will also contain the proper electronics for converting alternating current (120 volts) to low voltage, wireless capability, control, on/off switch and also having a lithium battery to provide power when alternating current (120 volts) is not available. In addition, the housing will contain a speaker as shown in (FIG. 1C) which consists of the speaker frame, magnet, voice coil, speaker cone and dust cover. Lastly, the speaker grille as shown in (FIG. 1D) will fasten to the bottom of the plastic and/or metal housing to protect the speaker.

1. I Richard S. Mosher claim this improved ceiling fan invention consisting of a ceiling fan with an audio speaker device.
